(19) United States
(12) Patent Application Publication
(10) Pub. No.: US 2022/0193553 A1
(43) Pub. Date: Jun. 23, 2022

(54) SYSTEMS AND METHODS FOR EMBEDDED VIDEO STREAMS

(71) Applicant: Madison Kruse, Waterloo, IL (US)

(72) Inventor: Madison Kruse, Waterloo, IL (US)

(21) Appl. No.: 17/527,788

(22) Filed: Nov. 16, 2021

Related U.S. Application Data
(60) Provisional application No. 63/115,962, filed on Nov. 19, 2020.

(51) Int. Cl. A63F 13/65; H04N 21/4402; H04N 21/431; A63F 13/86

(52) U.S. Cl. CPC A63F 13/65; H04N 21/440263; A63F 2300/577; A63F 13/86; A63F 2300/69; H04N 21/4316

(57) ABSTRACT

Systems and methods for embedding multiple video streams within a single display. The systems and methods comprise trimming or clipping a first video feed (generally the output of a video game being played by the streamer) to fit within the minor axis width of a mobile device display in portrait mode. Additionally, a second video stream (generally the headshot feed of the streamer), is likewise trimmed and resized to fit within the same width. Blank space within the image is then filled in with blurred content extensions, generally from the first video stream, which provides a smooth and uniform color palette, and subdues perceived animation to provide an overall pleasing visual experience.

### CROSS-REFERENCE TO RELATED APPLICATIONS

This application claims the benefit of U.S. Prov. Pat. App. No. 63/115,962, filed Nov. 19, 2020, the entire disclosure of which is incorporated herein by reference.

### BACKGROUND OF THE INVENTION

### Field of the Invention

This disclosure is related to the field of handheld mobile device displays, and more particularly to a method of embedding a first video stream within a second stream.

### Description of the Related Art

The proliferation of handheld mobile devices has revolutionized the way that consumers enjoy content. From streaming services to video games, these small computers in our pockets have made content more accessible than ever. However, this convenience comes at an often overlooked price.

Handheld device displays are almost universally rectangular, having a longer major axis and a shorter minor axis, and most are capable of being used in multiple orientations. In “portrait” orientation, the device is held with the shorter dimensions at the top and bottom and the longer dimensions along the side (like a portrait), and the device can generally be operated with one hand in this orientation. This makes it convenient for everyday use, permitting the user a free hand to perform other tasks. In “landscape” orientation, the device is held with the long dimensions at the top and bottom and the shorter longer dimensions along the side. The device is more difficult to hold in this orientation without obscuring the screen or using two hands, but this orientation is preferred for audiovisual content, most of which is produced for consumption on conventional screens such as television, and thus is produced in landscape format.

This creates problems when trying to consume content on a handheld device. Although there are often differences between the native aspect ratio of any given content and that of the screen, these differences are generally negligible if the screen is oriented the same as the content. That is, a computer video game rendered in landscape orientation may not have the exact same ratio as a given mobile device in landscape orientation, but the differences are generally modest enough that the content can be displayed on the mobile device to occupy most or all of the available screen space. However, when the content is produced in landscape orientation but the device is held in portrait orientation, a large amount of screen space is wasted. This results in black bars at the tops or sides of the screen to fill in the space. Such black bars are known to be unattractive and unappealing, and to reinforce the consumer's impression that the content was not meant to be viewed on the device.

These difficulties become even more acute when attempting to combine multiple content streams within one device screen. This is often done with video game content by streamers. Streamers are professional or hobby video game players who “live stream” the games they are playing over various social media platforms. The live stream typically compromises a video, and sometimes also an audio, feed of the game that the streamer is playing so that viewers can experience what the streamer is seeing at the same time. Additionally, streamers typically set up a video camera capturing a headshot of the streamer, which captures emotions, expressions, and allows the streamer to showcase his or her personality. The headshot is often embedded as a small sub-window within the output feed from the video game, allowing the audience to see most of the game action while also enjoying the streamer's responses and reactions.

Although this is relatively easy to do on a full size display, such as a television or computer monitor, it is much more difficult on a mobile device. This is because, on a larger screen, the headshot of the streamer can be reduced to a relatively small subportion of the screen in a corner, leaving the vast majority of the screen space available for showing the game being played. However, on a mobile device, maintaining the same ratio of screen space between the headshot of the streamer and the game feed would cause the streamer headshot to be so small that the viewer could not discern the streamer's expressions and emotions. This defeats one of the main entertainment benefits of watching streamers, which is to witness and experience emotions and responses to what is happening in the game in real time. However, if the streamer's headshot is increased in size to be easier to see, it occupies too much screen space on a mobile device, leaving insufficient screen space to display the video game feed. This problem is especially acute in portrait mode, where displaying content produced in landscape orientation results in a substantial loss of detail.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a non-transitory computer-readable storage medium having program instructions thereon, wherein the instructions, when executed by at least one microprocessor, cause the at least one microprocessor to perform the following operations: receiving a first video feed comprising video output of a video game being played by a player, the first video feed having a height and a width defining a landscape orientation aspect ratio, the native width being greater than the native height; receiving a second video feed comprising a headshot stream of the player while the player plays the video game, the second video feed having an aspect ratio and being received simultaneously and in real-time with the received first video feed; segmenting a display having a portrait orientation width and a portrait orientation height greater than the portrait orientation width into: a first segment having a first segment height and a first segment width, the first segment width being about equal to the portrait orientation width; and a second segment having a circular configuration comprising a diameter, the diameter being less than the portrait orientation width, the second segment being disposed above and adjacent to the first segment and a portion of the second segment overlapping the first segment; modifying the first video feed for display in the first segment, the modifying comprising: resizing the received first video feed such that the first video feed height is about equal to the first segment height and the first video feed width is effective to cause the resized video feed to maintain the landscape orientation aspect ratio; truncating a left side and a right side of the resized first video feed such that the resized first video feed has a first video feed width about equal to the first segment width; displaying the modified first video feed in the first segment; modifying the second video feed for display in the second segment, the modifying comprising resizing the second video feed to have a height and width corresponding to the diameter of the second segment, the modified height and width effective to cause the modified second video feed to maintain the second video feed aspect ratio; and displaying in the second segment a circular portion of the modified second video feed centered on the face of the player.

In an embodiment of the non-transitory computer-readable storage medium, the program instructions, when executed by at least one microprocessor, further cause the at least one microprocessor to perform the following operations: segmenting the display into a top additional segment disposed above, adjacent to, and partially underlapping the second segment, the top additional segment having a width about equal to the portrait orientation width.

In a further embodiment of the non-transitory computer-readable storage medium, the program instructions, when executed by at least one microprocessor, further cause the at least one microprocessor to perform the following operations: duplicating the first video stream as a first duplicate video stream; modifying the first duplicate video stream, the modifying comprising resizing the first duplicate video stream and obscuring the first duplicate video stream; and displaying, in the top additional segment, a portion of the modified first duplicate video stream.

In a further embodiment of the non-transitory computer-readable storage medium, the program instructions, when executed by at least one microprocessor, further cause the at least one microprocessor to perform the following operations: segmenting the display into a bottom additional segment disposed below and adjacent to the first segment, the bottom additional segment having a width about equal to the portrait orientation width.

In a further embodiment of the non-transitory computer-readable storage medium, the program instructions, when executed by at least one microprocessor, further cause the at least one microprocessor to perform the following operations: duplicating the first video stream as a second duplicate video stream; modifying the second duplicate video stream, the modifying comprising resizing the second duplicate video stream and obscuring the second duplicate video stream; and displaying, in the bottom additional segment, a portion of the modified second duplicate video stream.

In a further embodiment of the non-transitory computer-readable storage medium, the portion of the modified first duplicate video stream displayed in the top additional segment is a top portion of the modified first duplicate video stream.

In a further embodiment of the non-transitory computer-readable storage medium, the portion of the modified second duplicate video stream displayed in the bottom additional segment is a bottom portion of the modified second duplicate video stream.

In a further embodiment of the non-transitory computer-readable storage medium, the program instructions, when executed by at least one microprocessor, further cause the at least one microprocessor to perform the following operations: streaming, over a telecommunications network, the content displayed on the display.

Also described herein, among other things, is a method for embedding multiple video streams on a display comprising: receiving a first video feed comprising video output of a video game being played by a player, the first video feed having a height and a width defining a landscape orientation aspect ratio, the native width being greater than the native height; receiving a second video feed comprising a headshot stream of the player while the player plays the video game, the second video feed having an aspect ratio and being received simultaneously and in real-time with the received first video feed; segmenting a display having a portrait orientation width and a portrait orientation height greater than the portrait orientation width into: a first segment having a first segment height and a first segment width, the first segment width being about equal to the portrait orientation width; and a second segment having a circular configuration comprising a diameter, the diameter being less than the portrait orientation width, the second segment being disposed above and adjacent to the first segment and a portion of the second segment overlapping the first segment; modifying the first video feed for display in the first segment, the modifying comprising: resizing the received first video feed such that the first video feed height is about equal to the first segment height and the first video feed width is effective to cause the resized video feed to maintain the landscape orientation aspect ratio; truncating a left side and a right side of the resized first video feed such that the resized first video feed has a first video feed width about equal to the first segment width; displaying the modified first video feed in the first segment; modifying the second video feed for display in the second segment, the modifying comprising resizing the second video feed to have a height and width corresponding to the diameter of the second segment, the modified height and width effective to cause the modified second video feed to maintain the second video feed aspect ratio; and displaying in the second segment a circular portion of the modified second video feed centered on the face of the player.

In a further embodiment of the method, the method further comprises: segmenting the display into a top additional segment disposed above, adjacent to, and partially underlapping the second segment, the top additional segment having a width about equal to the portrait orientation width.

In a further embodiment of the method, the method further comprises: duplicating the first video stream as a first duplicate video stream; modifying the first duplicate video stream, the modifying comprising resizing the first duplicate video stream and obscuring the first duplicate video stream; and displaying, in the top additional segment, a portion of the modified first duplicate video stream.

In a further embodiment of the method, the method further comprises: segmenting the display into a bottom additional segment disposed below and adjacent to the first segment, the bottom additional segment having a width about equal to the portrait orientation width.

In a further embodiment of the method, the method further comprises: duplicating the first video stream as a second duplicate video stream; modifying the second duplicate video stream, the modifying comprising resizing the second duplicate video stream and obscuring the second duplicate video stream; and displaying, in the bottom additional segment, a portion of the modified second duplicate video stream.

In a further embodiment of the method, the portion of the modified first duplicate video stream displayed in the top additional segment is a top portion of the modified first duplicate video stream.

In a further embodiment of the method, the portion of the modified second duplicate video stream displayed in the bottom additional segment is a bottom portion of the modified second duplicate video stream.

In a further embodiment of the method, the method further comprises streaming, over a telecommunications network, the content displayed on the display.

In a further embodiment of the method, the method further comprises receiving, by a plurality of computers, the streamed content.

### BRIEF DESCRIPTION OF THE DRAWINGS

FIG. 1 depicts an embodiment of system for embedding multiple streams according to the present disclosure.

FIG. 2 depicts an embodiment of the system for embedding multiple streams of FIG. 1 with the displayed content omitted.

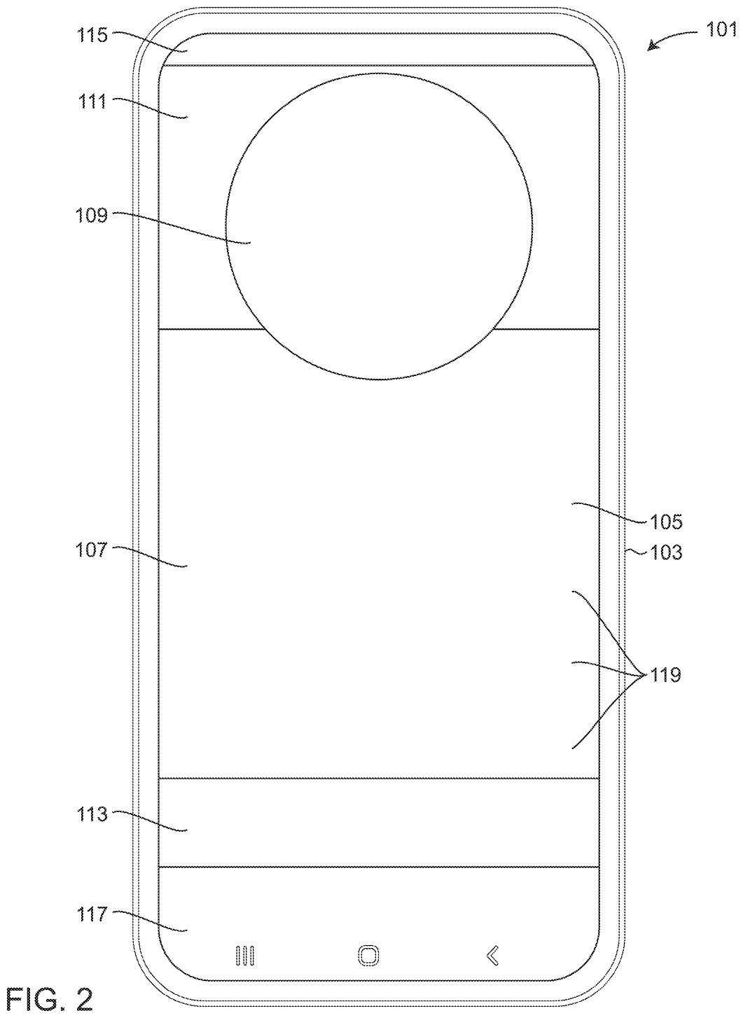

FIG. 3 depicts an alternative embodiment of the system for embedding multiple streams of FIG. 1 with a comment overlay omitted.

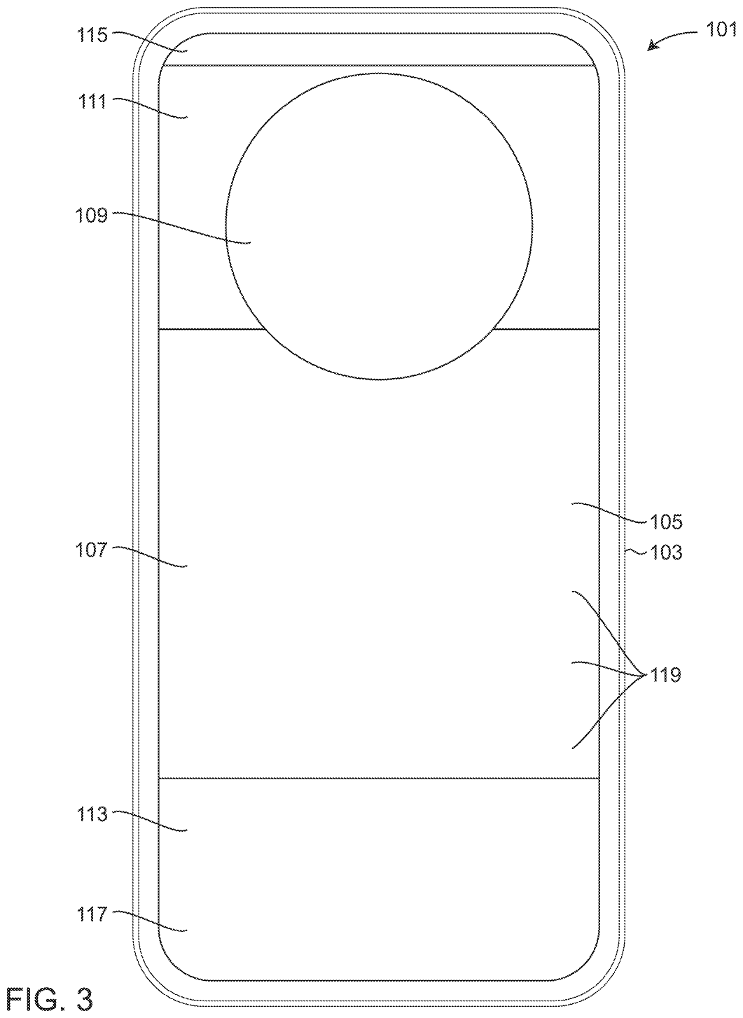

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein, among other things, are systems and methods for embedding multiple video streams within a single display. At a high level of generality, the systems and methods comprise trimming or clipping a first video feed (generally the output of a video game being played by the streamer) to fit within the minor axis width of a mobile device display in portrait mode. Additionally, a second video stream (generally the headshot feed of the streamer), is likewise trimmed and resized to fit within the same width. Blank space within the image is then filled in with blurred content extensions, generally from the first video stream, which provides a smooth and uniform color palette, and subdues perceived animation to provide an overall pleasing visual experience.

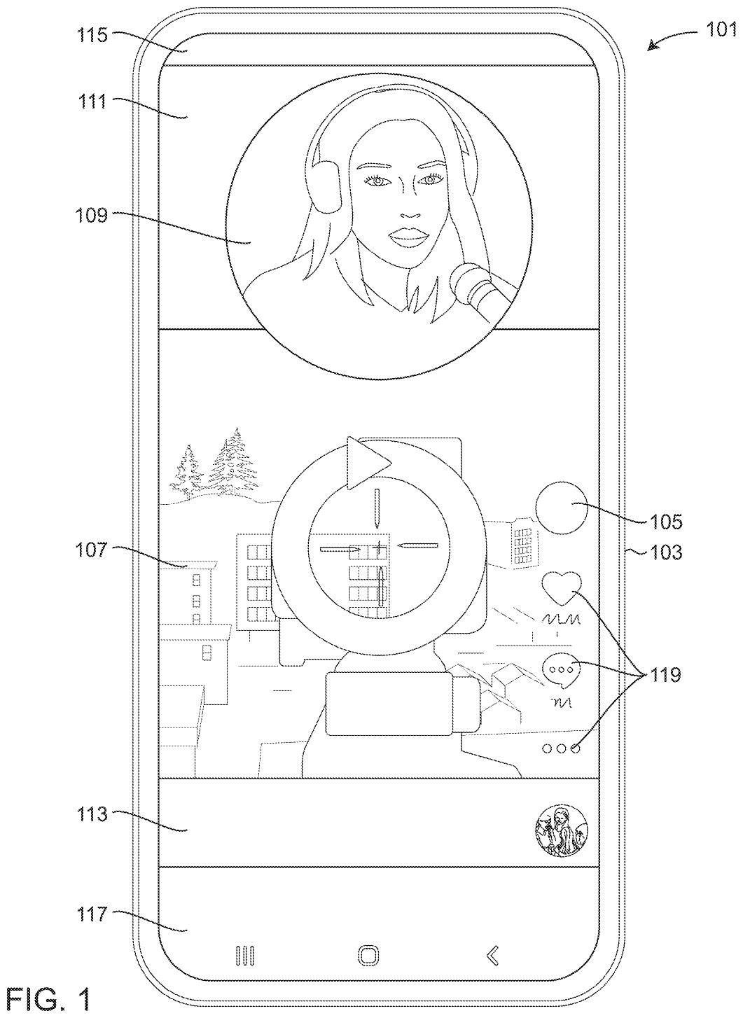

FIG. 1 depicts an embodiment of the systems and methods described herein. In the depicted embodiment of FIG. 1, a mobile device (103) is shown having a display (105). The mobile device (103) may further comprise mechanical interface features such as buttons as will be familiar to one of ordinary skill in the art. The depicted display (105) is typically an LCD or other display hardware system which is controlled by the operating system of the mobile device (103). The display (105) has a native or inherent resolution and aspect ratio, and as the mobile device (103) is rotated from landscape to portrait mode and back, the display typically changes to cause the content being displayed to use as much as of the screen space as possible.

In the depicted embodiment, software configurations are used to segment the screen space into a plurality of sections for multiple video feeds. These include a first video feed section (107) and a second video feed section (109). The first video feed section (107) receives and displays a first video stream, and the second video feed section (109) receives and displays a second video stream. One of these video streams are generally the output from a video game or other content being enjoyed or consumed by a host or streamer (referred to herein as the “content stream”), and the other is generally the output of an image capture technology, such as a digital camera, focused on a headshot of the host or streamer (referred to herein as the “headshot stream”). The two video feeds are generally produced simultaneously in real-time, meaning that the headshot stream and content stream are synchronized, and the headshot stream depicts the real-time response of the streamer to what she or he is seeing in the content stream. The streams may be produced by a single computer device, or by multiple difference devices, depending on the particular recording configuration of the streamer.

Both video streams are generally produced in a native format that defines the resolution and aspect ratio of the image, which in turn imparts a native of production orientation. This means a specific number of pixels of width and height based on the software or technology used to acquire the video. Accordingly, each stream may need to be modified to fit within its respective video feed section (107) and (109) of the screen. Generally, the content feed is displayed in the first video feed section (107), and the headshot heed is displayed in the second video feed section (109).

Because the content feed will generally use the dimensions of a monitor, or television, it may need to be modified to fit within the first video feed section (107). Of note, the width of the content stream generally cannot both fit within the first video feed section (107) and also use all of the vertical space on the screen. To address this, the content stream may be clipped, trimmed, or otherwise modified to cause its width to be equal to or less than the width of the display (105), so that the modified content stream can be displayed within the first video feed section (107).

However, it is desirable that the width of the content stream not be aggressively truncated, or the resulting modified video stream would contain a tall, thin sliver of the content stream, which may not provide enough visual context for the viewer to understand what is happening in the game. That is, although it is possible to modify the content stream so that it fills the entire vertical space of the display (105), this would require a substantial amount of the width of the content stream to be lost. Thus, in the depicted embodiment, the first video feed section (107) is shorter in height than the overall vertical dimension of the screen (105), which in turn means that less of the width of the content stream is truncated to fit the content stream within the first video feed section (107).

The first video feed section (107) is thus sized and shaped to achieve an aspect ratio for the modified content stream that strikes a balance between being as close as possible to the aspect ratio of the unmodified content stream, while also presenting a substantial amount of the content stream on screen. The exact amount of trimming to be done may vary from embodiment to embodiment depending on the nature of the game to be played. Some games have action highly centered on the middle of the screen and can be somewhat aggressively trimmed without losing viewer comprehension. Other games may have key interface elements at the edges which are important to comprehension.

As can be seen in the depicted embodiment, this results in two additional sections (111) and (113) disposed above and below the first video feed section (107), respectively. The first additional section (111) is disposed above the first video feed section (107) but beneath the status bar (115) for the mobile device (103). A second additional section (113) is disposed below the first video feed section (107).

It is undesirable in visual design to have blank space in an image. Thus, these additional sections (111) and 113) may be populated with content. This content may be excerpts from the content stream. For example, the top additional section (111) may be populated with a portion of the content stream, modified to deemphasize the content in this section (111) to avoid distracting the viewer from the modified content stream in the first video feed section (107). By way of example, and not limitation, a portion of the content stream may be magnified and blurred and displayed in the top additional section (111) so that it contains content with the same general color palette, tone, and animation as the content stream in the first video feed section (107), but displayed in a de-emphasized or obscured manner that does not distracting from the content stream in the first video feed section (107). Examples of such techniques include blurring and pixelating the content to render the details indistinct. Likewise, a similar technique may be used with respect to the other bottom additional section (113). The content displayed in the additional sections (111) and (113) may be still or animated (e.g., where the video game feed is used, the feed, and/or a portion of it, is effectively duplicated and modified for synchronized display in real-time in each of the additional sections).

In the depicted embodiment, the headshot stream is presented in the second video feed section (109). One aspect of successful streaming is establishing a rapport with the audience, which is best done by presenting a headshot so that the audience can see the streamer's emotions and reactions. In the depicted embodiment, the second video feed section (109) is in the shape of a circle. However, this is exemplary only, and, in an alternative embodiment, different shapes may be used. Generally, a circle is preferred for a headshot because it generally comports with the rough outline of the human head, and it captures enough of the streamer's facial characteristics and upper body to adequately convey body language and emotion, but without taking up unnecessary screen space than is needed. In the depicted embodiment, the second video feed section (109) also partially overlaps the first video feed section (107). Again, this is exemplary only, and other relationships are possible. Of note, the second video feed section (109) is proportionately much larger as compared to the first video feed section (107) than it would be in a streaming application using a conventional television screen or computer monitor.

In the depicted embodiment of FIG. 1, the display (105) may also include one or more overlays (119). These overlays (119) may be used to provide viewers with feedback mechanisms or other controls for interacting with the stream. In the depicted embodiment, a “Like” overlay (119) control is provided, along with a comment control, and an option menu to select other choices. In the depicted embodiment, a user interface segment (117) is also shown. This element may comprise any GUI elements, and may be configured to facilitate community engagement and interaction, such as by providing text comments or an interface to other forms of user input, such as activating the microphone or a voice-to-text system. In the depicted embodiment, the user interface segment (117) comprises a slide up user interface element or control (117). This control (117) may be omitted when the viewer has not accessed one of the overlay controls. In such circumstances, the content of the bottom additional section (113) may expand to cover the bottom of the screen, thus eliminating blank space.

The content stream and headshot stream are displayed in the first video feed section (107) and second video feed section (109), respectively, and in simultaneously synchronization. That is, the viewer receives the content of the first video feed section (107) at the same time as the streamer shown in the second video feed section (109). This enables the streamer and viewers experiencing the game content at the same time, and reacting together.

The content stream is generally from a video game (or other content, such as a movie, video, or television program), and may be acquired directly using software running on the computer that is running the game or displaying the content. Alternatively, it may be a video output feed provided by a separate device. Likewise, the headshot stream, usually of the streamer, may be acquired by a camera attached to the computer on which the streamer is playing the game or viewing of the content, or may be separately acquired through another image capture technology on another device.

The systems and methods described herein may be carried out on a single computer or a plurality of computers working in concert. By way of example and not limitation, a streamer may create the display described herein on a streamer computer system and then transmit the content to one or more recipients (or clients) over a telecommunications network. The recipient computers may then display the streamed content to users of such recipient computers.

It should be noted that the modifications to the video streams described herein may be achieved through a number of techniques. For example, a video stream itself may be modified (e.g., “clipped” or “truncated”) directly to match the dimensions of the segment in which it will be displayed. Alternatively, the amount and portion of the video stream displayed may be established using a mask or other graphic editing techniques, thereby also effectively “clipping” or “truncating” the video feed.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. In a typical embodiment, program instructions are stored on a non-transitory, computer-readable store medium.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a web site”), or an access point for a service over a network.

Throughout this disclosure, the term “real time” refers to software operating within operational deadlines for a given event to commence or complete, or for a given module, software, or system to respond, and generally invokes that the response or performance time is, in ordinary user perception and considered the technological context, effectively generally cotemporaneous with a reference event. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of no more than one second of actual time, with milliseconds or microseconds being preferable. However, those of ordinary skill in the art also understand that, under other operational contexts, a system operating in “real time” may exhibit delays longer than one second, particularly where network operations are involved.

For purposes of this disclosure, a specific type of computer referred to as a “mobile communication device” or simply “mobile device” may be referenced. A mobile device may be, but is not limited to, a smart phone, tablet PC, e-reader, satellite navigation system (“SatNav”), fitness device (e.g. a Fitbit™ or Jawbone™) or any other type of mobile computer whether of general or specific purpose functionality. Generally speaking, a mobile communication device is network-enabled and communicating with a server system providing services over a telecommunication or other infrastructure network. A mobile communication device is essentially a mobile computer, but one which is commonly not associated with any particular location, is also commonly carried on a user's person, and usually is in near-constant real-time communication with a network.

Throughout this disclosure, geometric terms may be used to characterize, among other things, sizes, shapes, dimensions, angles, distances, and relationships. These terms may be used with qualifiers such as “generally,” “about,” and “approximately.” One of ordinary skill in the art will understand that, in the context of this disclosure, these terms are used to describe a recognizable attempt to conform a device or component to the qualified term.

By way of example and not limitation, components described as being “generally coplanar” will be recognized by one of ordinary skill in the art to not be actually coplanar in a strict geometric sense because a “plane” is a purely geometric construct that does not actually exist and no component is truly “planer,” nor are two components ever truly coplanar. Variations from geometric descriptions are unavoidable due to, among other things, manufacturing tolerances resulting in shape variations, defects, imperfections, non-uniform thermal expansion, natural wear, minor variations that are nevertheless recognizable as the qualified term, and other deformations.

One of ordinary skill in the art will understand how to apply geometric terms, whether or not qualified by relative terms such as “generally,” “about,” and “approximately,” to describe a reasonable range of variations from the literal geometric term in view of these and other considerations appropriate to the context. Additionally, the use of the conjunctive and disjunctive should not necessarily be construed as limiting, and the conjunctive may include the disjunctive, and vice versa.

Similarly, mathematical terms may be utilized such as “equal to,” particularly with respect to the dimensions of display segments. For example, the display segments in the figures are shown as extending to the edges of the physical screen on the device, but a person of ordinary skill in the art will recognize that, for purposes of this disclosure, stopping just short of such dimensions would still be considered having a segment whose width is “equal to” or “about equal to” the width of the screen.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A non-transitory computer-readable storage medium having program instructions thereon, wherein the instructions, when executed by at least one microprocessor, cause said at least one microprocessor to perform the following operations:
receiving a first video feed comprising video output of a video game being played by a player, said first video feed having a height and a width defining a landscape orientation aspect ratio, said native width being greater than said native height;
receiving a second video feed comprising a headshot stream of said player while said player plays said video game, said second video feed having an aspect ratio and being received simultaneously and in real-time with said received first video feed;
segmenting a display having a portrait orientation width and a portrait orientation height greater than said portrait orientation width into:
a first segment having a first segment height and a first segment width, said first segment width being about equal to said portrait orientation width; and
a second segment having a circular configuration comprising a diameter, said diameter being less than said portrait orientation width, said second segment being disposed above and adjacent to said first segment and a portion of said second segment overlapping said first segment;
modifying said first video feed for display in said first segment, said modifying comprising:
resizing said received first video feed such that said first video feed height is about equal to said first segment height and said first video feed width is effective to cause said resized video feed to maintain said landscape orientation aspect ratio;
truncating a left side and a right side of said resized first video feed such that said resized first video feed has a first video feed width about equal to said first segment width;
displaying said modified first video feed in said first segment;
modifying said second video feed for display in said second segment, said modifying comprising resizing said second video feed to have a height and width corresponding to said diameter of said second segment, said modified height and width effective to cause said modified Second video feed to maintain said second video feed aspect ratio; and
displaying in said second segment a circular portion of said modified second video feed centered on the face of said player.

2. The non-transitory computer-readable storage medium of claim 1, wherein said program instructions, when executed by at least one microprocessor, further cause said at least one microprocessor to perform the following operations:
segmenting said display into a top additional segment disposed above, adjacent to, and partially underlapping said second segment, said top additional segment having a width about equal to said portrait orientation width.

3. The non-transitory computer-readable storage medium of claim 2, wherein said program instructions, when executed by at least one microprocessor, further cause said at least one microprocessor to perform the following operations:
duplicating said first video stream as a first duplicate video stream;
modifying said first duplicate video stream, said modifying comprising resizing said first duplicate video stream and obscuring said first duplicate video stream; and
displaying, in said top additional segment, a portion of said modified first duplicate video stream.

4. The non-transitory computer-readable storage medium of claim 3, wherein said program instructions, when executed by at least one microprocessor, further cause said at least one microprocessor to perform the following operations:
segmenting said display into a bottom additional segment disposed below and adjacent to said first segment, said bottom additional segment having a width about equal to said portrait orientation width.

5. The non-transitory computer-readable storage medium of claim 4, wherein said program instructions, when executed by at least one microprocessor, further cause said at least one microprocessor to perform the following operations:
duplicating said first video stream as a second duplicate video stream;
modifying said second duplicate video stream, said modifying comprising resizing said second duplicate video stream and obscuring said second duplicate video stream; and
displaying, in said bottom additional segment, a portion of said modified second duplicate video stream.

6. The non-transitory computer-readable storage medium of claim 5, wherein said portion of said modified first duplicate video stream displayed in said top additional segment is a top portion of said modified first duplicate video stream.

7. The non-transitory computer-readable storage medium of claim 6, wherein said portion of said modified second duplicate video stream displayed in said bottom additional segment is a bottom portion of said modified second duplicate video stream.

8. The non-transitory computer-readable storage medium of claim 1, wherein said program instructions, when executed by at least one microprocessor, further cause said at least one microprocessor to perform the following operations:
streaming, over a telecommunications network, the content displayed on said display.

9. A method for embedding multiple video streams on a display comprising:
receiving a first video feed comprising video output of a video game being played by a player, said first video feed having a height and a width defining a landscape orientation aspect ratio, said native width being greater than said native height;
receiving a second video feed comprising a headshot stream of said player while said player plays said video game, said second video feed having an aspect ratio and being received simultaneously and in real-time with said received first video feed;
segmenting a display having a portrait orientation width and a portrait orientation height greater than said portrait orientation width into:
a first segment having a first segment height and a first segment width, said first segment width being about equal to said portrait orientation width; and
a second segment having a circular configuration comprising a diameter, said diameter being less than said portrait orientation width, said second segment being disposed above and adjacent to said first segment and a portion of said second segment overlapping said first segment;
modifying said first video feed for display in said first segment, said modifying comprising:
resizing said received first video feed such that said first video feed height is about equal to said first segment height and said first video feed width is effective to cause said resized video feed to maintain said landscape orientation aspect ratio;
truncating a left side and a right side of said resized first video feed such that said resized first video feed has a first video feed width about equal to said first segment width;
displaying said modified first video feed in said first segment;
modifying said second video feed for display in said second segment, said modifying comprising resizing said second video feed to have a height and width corresponding to said diameter of said second segment, said modified height and width effective to cause said modified second video feed to maintain said second video feed aspect ratio; and
displaying in said second segment a circular portion of said modified second video feed centered on the face of said player.

10. The method of claim 10, further comprising:
segmenting said display into a top additional segment disposed above, adjacent to, and partially underlapping said second segment, said top additional segment having a width about equal to said portrait orientation width.

11. The method of claim 11, further comprising:
duplicating said first video stream as a first duplicate video stream;
modifying said first duplicate video stream, said modifying comprising resizing said first duplicate video stream and obscuring said first duplicate video stream; and
displaying, in said top additional segment, a portion of said modified first duplicate video stream.

12. The method of claim 12, further comprising:
segmenting said display into a bottom additional segment disposed below and adjacent to said first segment, said bottom additional segment having a width about equal to said portrait orientation width.

13. The method of claim 13, further comprising:
duplicating said first video stream as a second duplicate video stream;
modifying said second duplicate video stream, said modifying comprising resizing said second duplicate video stream and obscuring said second duplicate video stream; and
displaying, in said bottom additional segment, a portion of said modified second duplicate video stream.

14. The method of claim 14, wherein said portion of said modified first duplicate video stream displayed in said top additional segment is a top portion of said modified first duplicate video stream.

15. The method of claim 15, wherein said portion of said modified second duplicate video stream displayed in said bottom additional segment is a bottom portion of said modified second duplicate video stream.

16. The method of claim 9, further comprising streaming, over a telecommunications network, the content displayed on said display.

17. The method of claim 16, further comprising receiving, by a plurality of computers, said streamed content.
